(19) United States
(12) Patent Application Publication
(10) Pub. No.: US 2003/0016222 A1
(43) Pub. Date: Jan. 23, 2003

(54) Process for utilizing a pressure and motion sensitive pad to create computer generated animation

(76) Inventors: Clay A. Budin, Brooklyn, NY (US); David J. Fleischer, Hopewell, NJ (US); Doug G. Johnson, Brooklyn, NY (US)

Correspondence Address: MATTINGLY, STANGER & MALUR, P.C., SUITE 370, 1800 DIAGONAL ROAD, ALEXANDRIA, VA, 22314, US

(21) Appl. No.: 10/106,365

(22) Filed: Mar. 27, 2002

Related U.S. Application Data
(60) Provisional application No. 60/278,753, filed on Mar. 27, 2001.

(51) Int. Cl. G06T 13/00

(52) U.S. Cl. 345/473

(57) ABSTRACT

The present invention is a process for translating tactile movement from a pressure and motion sensitive input device into computer generated image animation.

Applicants hereby claim the benefit of provisional patent application Serial No. 60/278,753, filed Mar. 27, 2001. The application is incorporated by reference herein in its entirety.

### BACKGROUND OF THE INVENTION

The following are the steps an animator currently uses when animating a computer generated image character:

1. Build a model of the character.

2. Create blend shapes representing visemes for speech, plus the necessary complement of facial emotions, blinks, eyebrow raises, etc.

3. Attach the character model to a skeleton (otherwise known as rigging).

4. Hook all the blend shapes up to the head model.

5. Using the audio track, create the lip synchronization (“lip sync”). Lip sync is the matching the constructed visemes with their phoneme analogues in the audio track.

6. Once the lip sync is done, the body motion is blocked out. There are several ways of blocking out body motion; however, each involves approaching the audio a sentence or a phrase at a time (or if there's no dialogue, in 2-4 second increments.) The animator must then go through and nail poses at key points. For a full body, this involves going through the whole skeleton, a bone at a time, positioning it, and keying it. Some animators do it in layers, moving the root node through the motion, then progressively refining the legs, the arms, the head, the fingers, etc. The net result, and the time involved, is essentially the same.

7. Prepare the eye animation, also known as lookat. Like the body motion blocking, this must be done in small pieces, going through the animation and locking the eyes down at key points.

8. Prepare the facial animation, i.e., the facial expressions, smiles, frowns, blinks, eyebrow raises, etc. As with the previous animation processes, this involves stepping through the animation and dropping poses at critical points. It is not as tedious as the body animation, because the facial expressions are accessible through slider banks, but putting together a whole performance is still quite time consuming.

9. Refinement. Good animation is the process of continual refinement. In theory, refinement takes place until the animator is happy with the performance. In reality, this goes on until the deadline, if there is even time to do it at all. It is a process of viewing the animation over and over, finding the bits that aren't reading well or moving properly, then going into a curve editor for each joint or blend shape, and pulling the key frames around until the animation looks and feels right.

10. Once the performance is complete, it remains to light and render the scene, including preparing backgrounds, character placement, lighting, shadows, etc., if it is for non-realtime applications, and to integrate if it is for realtime application.

### SUMMARY OF THE INVENTION

It is an object of this invention to links the power of dynamic real time rendering in a computer animation software package with a simple user input system.

It is another object of this invention to facilitate computer generated image animation layer by layer.

It is yet another object of this invention to resolve stability issues of the pad by balancing the impact of multiple pressure points on the pad.

It is a further object of this invention to allow a modular design of a GUI that allows the quick and intuitive design of new pad layouts with the configuration of the pad automatically mapping to the animation software

It is yet a further object of this invention to filtering of data makes the input of the pad for consistency.

The present invention provides animators a simple and inexpensive means of combining takes or layers of animation. Any function controlled within a high-end animation package can be mapped to any region of a pad and performed by an animator. A finger moving across a pad can effect the animation that months of animation used to be required to do. The present invention translates tactile movement from a pressure and motion sensitive pad into computer generated image animation. This image animation interface provides a more natural means of setting a computer generated image key poses through a new input interface templated with various layouts on the pad's surface.

The animator of new computerized generated image animation configures a tactile sensitive flat rubber input device to a computer workstation. The Tactex pad is an example of a tactile sensitive flat rubber input device has embedded optical sensors, surrounded by a metal border. It is about the size of the average mouse pad. The rubber surface of the pad is big enough for an animator to rest the fingertips of both hands. This device tracks the animators fingers based on both position and pressure in a defined layout and forwards that data to a commercially available computer graphics software package such as Alias|Wavefront Maya.

The Tactex pad may be used in conjunction with Maya and a computer software driver, to create a realtime input device that allows an animator to move a selection of a character's attributes in realtime. This approach combines elements of motion capture, puppeteering, and traditional cel animation to create animated performances, which can be combined and refined using traditional key framing techniques.

Specifically, this process can affects steps 6, 7 and 8, of the known process of animating a computer generated image character, previously disclosed in the Background of the Invention. For animating the body, step 6, the animator connects regions of the Tactex pad to pre-established poses representing, for example: happy, sad, arms crossed, pointing or whatever is required for the performance. By sliding fingers over the pad, the animator causes the character to go to the various poses that have been mapped out. By applying pressure to the pad, the poses can be made stronger or weaker. As the soundtrack is played, the animator “plays” the character's motion on the pad, and this motion is recorded. Using scripts and code, the animator can record as many takes as desired, and choose between them to get the best set of performances. The advantage over key framing here is clear: since the performances are in realtime, the amount of motion that can be recorded in a day is only limited by the difficulty of the performance, the skill of the animator in playing the Tactex pad, and the number of layers of animation needed to reach the desired level of complexity.

For eye motion and facial animation, the steps are similar—one has to but select the desired configuration of the pad, and hook up the proper animation channels. Then it's just a matter of recording layers (for example: broad emotions, then specific mouth emotions, eyebrow movement details, then eye blinks), mixing them together to get the final performance.

### BRIEF DESCRIPTION OF THE DRAWINGS

FIG. 1 is an illustration of a hand engaging a Tactex Pad and the resulting computer generated face animation images.

FIG. 2 is a schematic of computer generated face animation images.

### DETAILED DESCRIPTION OF THE PREFERRED EMBODIMENT

In the present invention, a driver application is used to connect the Tactex pad to Alias|Wavefront Maya and acts as an interface between the application program interfaces (“APIs”) provided by Tactex and Alias|Wavefront for processing data in their respective applications. The driver application uses these APIs to handle the establishment of high-level connections to the Tactex pad and to Maya, and then samples incoming pad data, computationally processes it and transmits it to Maya. The driver application provides buffering and filtering functions, analysis of the data provided from the pad and interpretation of the data in terms of a specified organization of the pad surface into areas of pre-defined meaning. The driver application implements a system of gradual decrease of pressure on the pad and return to a zero-value. It supports a plug-in-like mechanism for easily adding additional layouts driven by a graphical user interface to make the creation of new layouts a simple and non-technical process. Finally, it provides a user interface for visualizing user actions relative to the current layout, calibration of the regions in the layout and the ability to control a wide variety of parameters, such as sensitivity and amount of filtering applied.

The Tactex API provides support for and handling of establishing a connection to the pad via a serial port, low-level device sampling of the pad, and transmission of data across the serial connection and into buffers in the host machine, as well as mapping and normalization functions. The data is made available to the application developer as an array of short integers, representing sampled and normalized pressure values for each sensor in the pad (known as a “taxel.”) Tactex API provides a higher-level function to analyze the taxel array data to determine the position and pressure of a specified number of “pointers” or regions of localized pressure, such as a finger press. This is necessary since one point of contact with the pad often results in the activation of several neighboring taxels. However, this provided function proved inadequate for our needs, and a different algorithm is implemented to improve performance (see below). The Alias|Wavefront API provides support for connection to Maya via the sockets network protocol, and uses a command-based mechanism for handshake, data polling and data recording requests. From the point of view of Maya, the application is a data server, which provides data upon request to Maya. This server appears in Maya as a “device” the outputs of which can be arbitrarily connected to any animatable parameter within a scene to drive that parameter's value. A number of scripts were written in MEL, the Maya scripting language, to facilitate the establishment of the connection to the driver application. All windows and user-interface items were implemented using the FLTK public-domain library. The new driver application begins by querying the user via a windows-based GUI for the COM port to connect to and the type of pad layout desired. It has an “autoconnect” feature that automatically scans COM ports for the one the pad device is connected to. Upon successful connection, the new driver application presents two new windows. One has sliders (a user-interface element designed to move a marker between two positions (“slide” between them), and report back a value which is dependent upon the slider marker's relative position between the end markers) and other user-input widgets (a generic user-interface element, such as a button, checkbox, radio-button, text entry area or slider.) to control various parameters of processing of data coming from the pad, such as threshold, sensitivity, and level of filtering. The other window displays a real-time representation of the pad surface with the current layout, current pointers and an option to display the raw taxel data as well. The user may calibrate the layout to his desired positions by placing his fingers on the pad, and pressing a button, the layout automatically recenters all its active regions around the currently pressed positions (not all layouts require calibration).

The application then waits for Maya to establish a connection with it. Once that is done and some initial handshake information is passed back and forth, the application will respond to Maya's request for data by sampling the pad, processing the information, encoding it according to the current layout and transmitting it to Maya using the Alias|Wavefront device API.

The processing proceeds as follows: the normalized taxel array is fed to a routine which determines the locations and pressure values of the pointers, or points of contact, and compares those values to the active “regions” or sub-areas of the pad as specified in the layout. Different regions within a layout may use the pointer information in different ways. For example: one may specify that a pointer detected in that particular region will govern a slider value in the range 0 to 1 based on the pointer's location relative to some minimum and maximum positions. Another region may encode the pressure of the pointer detected there in the range 0 to 100, a third may report the x and y values and pressure of a pointer within a circular area on the pad, and yet a fourth may implement a blend between four different values depending on the quadrant of a circle in which the pointer is detected, with distance from the center of the circle being used to scale the intensity of the values.

An enhanced proprietary pointer-detection routine is run for the pad and inserted as part of the process because testing revealed the one supplied by Tactex as too unstable to be used as required. Separate, simultaneous finger presses on the pad had too much influence on each other and the lifting of one finger off the pad seriously perturbed the position of a pointer for a finger still in contact with the pad. A routine implementing “neighborhood suppression,” in which a maximal point of contact actually reduces the strength of all of its neighbors in the taxel array, is used. This enhanced routine better isolates each pointer and provides enhanced stability and accuracy for our needs.

In order to reduce random noise stemming from inherent inaccuracies in the hardware, all pointer data is subject to filtration before further processing occurs. We use a standard, second-order low-pass Infinite Impulse Response Filter to reduce high-frequency interference. The exact parameters are tunable within the control interface to allow for a user to determine the exact “feel” preferred.

The driver implements a gradual decline of pressure and return to a zero-value. So, when the user presses down on a region of the pad, then releases quickly, the value of that press will settle back to zero more gradually, over a user-specified amount of time. Five frames is a smooth blending period. This makes controlling a character with the pad easier and more intuitive, since there is a built-in softening and decay of the pressure values, leading to smoother animations generated automatically.

The driver supports clamping. Clamping is the ability to define base and target blendshapes as the outer limits of change allowed. Typically the base is defined as 0.0 and the target as 1.0. Any number between these two is some gradient between base and target. The animator can define no clamping and allow morphing to exceed the range of base and target. The animator can allow clamping individually by region and 0.0 and 1.0 bound that region. Or the animator can define and clamping of the sum of all regions. This last can be very useful in ensuring that a character does not go into an undesirable position as a result of having too many of its blend shapes pushed to 1.0 at the same time.

A GUI-based layout designer may also be implemented, which will allow non-technical people to design their own custom pad layouts. Drawing from a palette of basic building-block regions, such as sliders or circular regions. The designer has total control over all aspects of the layout, including what parameters are encoded, the ranges or pressure sensitivities. The layout is then saved in both human-readable and compiled object code, ready to be incorporated into the server application.

The pad is configurable; any animator can design optimal layouts. Overlay templates created by the animator can map optimal finger positions for puppeteering the layers of a computerized generated image performance. The defined areas of these templates are virtual keys. Like the keys in a keyboard they have specific rules and perform specific functions. Each virtual key acts on the animation in a defined way. A user interface allows animators to rest their fingers on the pad marking where the virtual keys will lie. Animators map mesh targets or poses to virtual keys and specify how keys can work together to blend the weights of poses or mesh targets allowing many poses or facial expressions to be blended together intuitively by the author. The blending happens dynamically to the animation with light pressure from multiple fingertips.

The animator can register a certain point or points on the pad as a base. Any motion on the pad away from that point or points can be mapped to progressively greater changes in the base animation. The same mapping can be done for pressure on the pad; the greater the pressure on the pad, the greater the change to the base animation. Both proximity to base and pressure can be used in different ways. For example, proximity could be mapped to the degree of facial expression and pressure could be mapped to color of the skin. The author moves fingers across the pad, in effect, performing the animation. The performance is recorded and can be altered in part or wholly in subsequent performances.

These techniques allow an animator to capture an entire sequence of key poses through a recorded performance, and therefore bear similarities to both motion capture techniques and puppetry.

An example of the process of an animator using the Tactex pad may created computer generated animation is as follows:

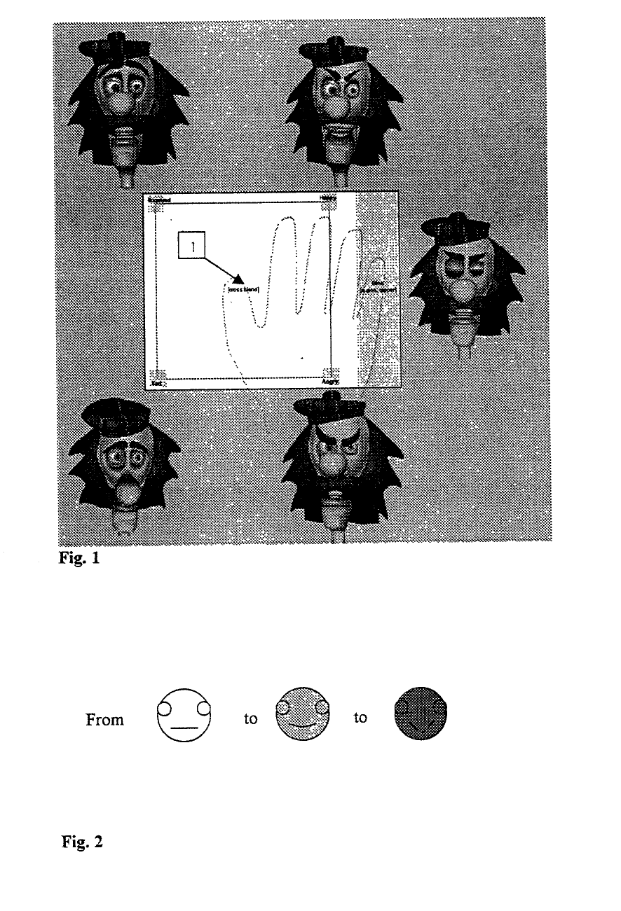

Referring to FIG. 1, an animator defines four quadrants of the pad as representing four different emotions for an animated character. Here are “surprised” on the upper left, “happy” on the upper right, “sad” on the lower left and “angry” on the lower right. “Blink” is given it's own area on the pad off on the right side.

Referring to FIG. 1, dragging a finger from the base center point (1) into the “Happy” quadrant moves the character from a defined base face to a progressively happier target face, as shown in FIG. 2. By pressing harder on the pad the character could change color.

The animator records the complete motion of the animation as played by the movement of finger across the quadrant in the buffers of the computer software animation package and plays back animation of the computer generated image and virtually puppets the computer generated image motion using finger proximity and pressure on the pad. Unlike what is displayed in FIG. 2, there is a full animation of the computer generated image rather than stills making a life-like 3D appearance possible. Each emotion of the computer generated image is mapped to defined actions or expressions in the animation of the computer generated image, so each of the quadrants would have specified actions on the computer generated image. When the author is done with a take of an animated sequence the performance is recorded. Editing can be done in several ways. One way is the non-real-time, keyframe to keyframe manner traditionally known to animators. Another is joining various takes in a manner similar to editing film. The layers used in the creation of animation facilitate the third. An animated character's stance and body attitude can be animated and puppeteered first. Then an arm gesture layer added with a facial expression layer to match the preceding two layers. All the tracks are combined producing a master.

What is claimed is:

1. A process for creating computer generated animation, the process comprising:
configuring a tactile input device to translate tactile movement into computer generated animation;
providing tactile movement to the tactile movement device.

2. The process of claim 1, wherein the tactile movement comprises lateral motion and pressure.

3. The process of claim 1, wherein the configuring of the tactile input device includes providing a driver application to connect the input device to computer generated animation software.

4. The process of claim 3, wherein the driver application user-variably permits clamping.

5. The process of claim 1, wherein the tactile input device is flat rubber pad with optical sensors.

6. The process of claim 1, wherein the configuring of the tactile input device includes a neighborhood suppression routine.

7. The process of claim 1, wherein the configuring of the tactile input device includes the utilization of a second-order low-pass impulse response filter.

8. The process of claim 1, wherein parameters of configuring the tactile movement device are tunable.

9. The process of claim 1, the process further comprising organization of a surface on the tactile input device into areas of pre-defined meaning.

10. The process of claim 9, wherein the areas correspond with specific actions of a computer generated image.

11. The process of claim 1, wherein a visual user interface is provided to display tactile movement.
